(19) United States
(12) Patent Application Publication
(10) Pub. No.: US 2005/0061184 A1
(43) Pub. Date: Mar. 24, 2005

(54) Printing process with edible inks

(76) Inventors: John R. Russell, Bedlington (GB); Andrew M. Candler, Loansdean (GB); Angela Wright, Ashington (GB)

Correspondence Address: FISH & RICHARDSON P.C., 3300 DAIN RAUSCHER PLAZA, 60 SOUTH SIXTH STREET, MINNEAPOLIS, MN, 55402, US

(21) Appl. No.: 10/932,912

(22) Filed: Sep. 2, 2004

Related U.S. Application Data
(63) Continuation-in-part of application No. 10/643,515, filed on Aug. 19, 2003.
Application No. 10/643,515 is a continuation of application No. 09/839,582, filed on Apr. 20, 2001, now Pat. No. 6,623,553.

(51) Int. Cl. B41C 1/00

(52) U.S. Cl. 101/483; 106/31.6; 106/31.86

(57) ABSTRACT

Edible ink compositions including plant-derived pigments are described, as well as printing processes using the same.

### CROSS-REFERENCE TO RELATED APPLICATIONS

This application is a continuation-in-part and claims the benefit of priority under 35 USC 120 of U.S. application Ser. No. 10/643,515, filed Aug. 19, 2003, which is a continuation of U.S. application Ser. No. 09/839,582, filed Apr. 20, 2001, now U.S. Pat. No. 6,623,553. The disclosure of the prior applications are considered part of (and are incorporated by reference in) the disclosure of this application.

### TECHNICAL FIELD

The present invention relates to decorated food articles and methods for making them. In certain embodiments, the invention relates to an edible ink composition, including an edible ink composition prepared with one or more plant-derived pigments, as well as a printing process for making a decorated food article with the ink composition.

### BACKGROUND

The mass-market appeal of movie, television, and sports has created a demand for confections and other food articles with multi-colored decorations bearing the likenesses of media, novelty, and/or entertainment figures. Typically, a food article is printed with a desired image using an edible ink composition. Bakeries, supermarkets and other food retailers have used increasingly sophisticated printing techniques to create these images on food articles.

For example, in a screen printing process, positive images are created from an artwork design. Using this positive image, printing screens are exposed and developed to include a negative image of the artwork design. A first color of an edible ink is then sprayed through the screen and onto a surface of a substrate, typically an icing layer or a sugar sheet, to form an image layer on the surface of the substrate. This step is repeated, one color at a time, until the multi-colored image is formed on the surface of the substrate. In another well known process, a first color of an edible ink may be applied to a pad of an automatic pad transfer printer. The pad is then contacted with a hard, non-porous surface of an icing layer on a confection to form an image layer thereon. This step is repeated, one color at a time, until a multi-colored image layer is formed. In the alternative, the artwork may be electronically scanned and the image file downloaded to an ink jet printer having a cartridge filled with at least one edible ink. The ink jet printed then applies the ink to a surface of a substrate to form an image layer thereon.

These techniques are much more efficient than a hand decorating process, and have made possible the creation of larger numbers of high-quality decorated food articles for purchase by a consumer. However, these techniques are relatively slow and unsuited for high volume production of food articles. In addition, consumers have demonstrated an increased preference for food articles, including decorations, that are free from artificial colors, flavors, or preservatives.

In the commercial printing industry, lithographic printing processes are routinely used for high volume production of highly precise single or multi-colored images on paper articles. In the lithographic process, also referred to as offset, litho-offset, web and offset lithography, an ink receptive image is typed or drawn on a master or produced photographically on a sensitized photopolymer plate. An ink is applied to the imaged master or plate to form an ink layer thereon, and the master is then placed on the master cylinder of an offset printing press. The ink layer built up on the master is then transferred to a surface of a rubber blanket cylinder, and the ink layer is subsequently transferred to a paper substrate as the paper passes between the blanket cylinder and an impression cylinder.

Compared to screen printing or inkjet printing processes, lithographic printing makes possible increased production speeds, improved quality in the reproduction of fine tones, and a substantial reduction in the number of impressions required to reproduce full color images.

### SUMMARY

In view of the cost and image quality advantages that lithographic printing provides compared to conventional screen printing and inkjet printing processes, it would be desirable to print food articles lithographically with edible inks. Accordingly, in one aspect, the invention provides an edible ink that is capable of being used in a lithographic or other high speed printing process. An edible ink can include at least one pigment, including soluble and/or insoluble pigments, that is free from artificial colors, flavors, or preservatives. For example, a pigment can be plant-derived, e.g., derived or extracted from fruits or vegetables. An edible ink can include a pigment to provide a preferred pigment density of about 0.1 grams/liter to about 0.25 g/l and a preferred ink density of about 1.1 g/l to about 2.0 g/l.

An edible ink can have a viscosity of about 1000 to about 16000 cp at 25° C., e.g., about 2000, 3000, 4000, 5000, 6000, 7000, 8000, 9000, 10000, 11000, 12000, 13000, 14000, or 15000 cp, or any range therebetween (e.g., from about 1000 to about 5000; from about 2000 to about 10000; from about 3000 to about 12000; from about 13000 to about 16000 cp).

In a second aspect, the invention is a printing process in which the edible ink is applied to an edible or inedible substrate. Preferably, the printing process is a lithographic printing process for forming an image layer on a substrate. In this process a layer of the edible ink is built up on a master, which is a photopolymer plate that includes an ink receptive image, to form an ink layer thereon. The ink layer is then transferred to a substrate in a lithographic printing press.

In a third aspect, the invention is a substrate having thereon an image layer of the edible ink.

In a fourth aspect, the invention is a decorating kit for use in printing on a surface of a substrate such as a lithographic printing master or an edible article such as a cake, candy and the like. The decorating kit includes a master or substrate and the edible ink.

The details of one or more embodiments of the invention are set forth in the accompanying drawings and the description below. Other features, objects, and advantages of the invention will be apparent from the description and drawings, and from the claims.

### DETAILED DESCRIPTION OF ILLUSTRATIVE EMBODIMENTS

In this application, all percentages are by weight unless otherwise indicated. The term edible ink as used in this application refers to any composition that is suitable for human consumption and forms an image layer on an edible or inedible substrate in a commercially feasible time. Edible inks suitable for human consumption comply with applicable standards such as FD&C regulations in the United States and E.E.C. standards in the European Union.

The edible inks described herein are capable of being used in a printing process to form an image layer on an edible or inedible substrate. The image layer on the substrate may include a single color or multiple colors, and should have acceptable definition, tonal value and registration to be useful as a decoration.

The edible ink preferably has a viscosity and a density sufficient to spread evenly over a master printing plate, adhere to the master printing plate, and subsequently transfer from the master to an edible article or a transfer sheet to form an image layer thereon. The viscosity of the edible ink may vary widely depending, for example, on the characteristics of the ink receptive layer on the master, the characteristics of the surface of the edible article or transfer sheet, the required drying time, and the like. Preferably, the edible ink has a viscosity of about 1000 to about 16000 cp at 25° C., e.g., about 2000, 3000, 4000, 5000, 6000, 7000, 8000, 9000, 10000, 11000, 12000, 13000, 14000, or 15000 cp, or any range therebetween (e.g., from about 1000 to about 5000; from about 2000 to about 10000; from about 3000 to about 12000; or from about 13000 to about 16000 cp). In certain cases, the edible ink has a viscosity from about 2400 to about 3100 cp, or from about 2900 to about 3000 cp, e.g., as measured by a number 2 aperture Zahn cup at 25° C.

To provide a properly colored image, the edible ink optionally includes one or more soluble or insoluble pigments. A pigment can be free from artificial colors, flavors, or preservatives. For example, a pigment can be plant-derived., e.g., derived or extracted from fruits or vegetables. A plant-derived pigment can be an extract from a variety of plants, e.g., red currant, black currant, carrot, black carrot, blueberries, cabbage, red cabbage, spinach, safflower, hibiscus, beet (e.g., red beet, golden beet), rose, tomato, strawberry, elderberry, raspberry, cherry, blackberry, plum, grape (e.g., blue grapes, purple grapes, red grapes), asparagus, bell pepper, broccoli, grass, lucerne, nettle, alfalfa, algae, and curcumin. Plant-derived pigments and extracts are available commercially, e.g., from GNT International B.V., Netherlands.

One or more pigments can be present in a sufficient concentration to provide a pigment density of about 0.1 g/l to about 0.25 g/l. The edible ink can have a density, referred to herein as the ink density, of about 1.1 g/l to about 1.4 g/l, or about 1.15 g/l to about 1.40 g/l. The percentage by weight of one or more pigments can vary according to consumer preference and end product considerations, such as the final color to be achieved (e.g., by blending one or more plant-based extracts), and viscosity, stickiness, and printing considerations.

If the edible article or transfer sheet is to be transported or stored without freezing, the edible ink may be formulated as an aqueous composition. An aqueous composition can include water, one or more sweeteners, one or more plant-derived pigments, one or more emulsifiers, and one or more humectants. Optional ingredients include one or more preservatives and/or pH regulators.

An aqueous edible ink composition can include about 3% to about 20% by weight (e.g., about 4%, 5%, 6%, 7%, 8%, 9%, 10%, 11%, 12%, 13%, 14%, 15%, 16%, 17%, 18%, or 19%) water. In certain cases, an aqueous composition can include about 11% to about 14% water; or about 8% to about 14% water; or about 6 to 14% water; or about 3% to about 5% water.

A sweetener provides flavor, enhances adherence to the printing plate (stickiness), acts as a pigment carrier, and functions as a diluent in the ink compositions. Suitable sweeteners can be selected from the group consisting of sugar, fructose, sucrose, aspartame, dextrose, dextrose monohydrate, glucose, glucose syrup, icing cane sugar, fondant icing sugar, and invert sugar, or mixtures thereof. Sweeteners can be present at from about 30% to about 60% by weight, or any value therebetween (e.g., 31%, 32%, 33%, 34%, 35%, 36%, 37%, 38%, 39%, 40%, 41%, 42%, 43%, 44%, 45%, 46%, 47%, 48%, 49%, 50%, 52%, 54%, 56%, 58%, or 59%). In certain cases, a sweetener may be present at from about 31% to about 43, or from about 27% to about 35%, or from about 24% to about 58%, or from about 30% to about 50% by weight. In some edible ink compositions, fondant icing sugar, invert sugar, or mixtures thereof are used as sweeteners.

An edible ink composition can include one or more emulsifiers and/or hydrocolloid stabilizers. These compounds act as a stabilizer and/or a thickening agent, and additionally enhance the release properties of the ink. An emulsifier can be present from about 1 to about 6% by weight, or any value therebetween (e.g., 1.1, 1.2, 1.3, 1.4, 1.5, 1.6, 1.7, 1.8, 1.9%, 2%, 2.2%, 2.5%, 2.8%, 3%, 3.2%, 3.5%, 3.8%, 4%, 4.2%, 4.5%, 4.8%, 5%, 5.2%, 5.5%, and 5.8%). In some cases, an emulsifier can be present from about 1% to about 2%, or from about 2% to about 4%, or from about 3% to about 5%, or from about 2% to about 4%, or from about 4% to about 6%. In other cases one or more emulsifiers can be present from about 15% to about 45% by weight (e.g., 15%, 16%, 17%, 18%, 19%, 20%, 21%, 22%, 25%, 28%, 30%, 31%, 32%, 33%, 34%, 35%, 36%, 37%, 38%, 39%, 40%, 41%, 42%, 43%, or 44%). For example, in some cases one or more emulsifiers can be present in an amount of from about 20% to about 30%, from about 15% to about 30%, from about 30% to about 40%, from about 35% to about 45%, or from about 15% to about 25%. An emulsifier can be selected from the group consisting of polysorbate 80, Tween 80, polysorbate 60, Tween 60, glycerin, polyoxyethylene sorbitan monostearate, crillet, polyglycerol polyricinoleate, acetic esters of monoglycerides, citric acid esters, lecithin, and mixtures thereof. In certain cases, an emulsifier can be lecithin, polysorbate 80, or a mixture of lecithin and polysorbate 80.

An edible ink composition can include one or more humectants, which can be selected from the group consisting of xylitol, mannitol, polyethylene glycol, propylene glycol, sorbitol, and mixtures thereof. One or more humectants can be added in a range of about 0.5% to about 10%, or any value therebetween (1%, 1.5% 2%, 2.5%, 3%, 3.5%, 4%, 4.5%, 5%, 5.5%, 6%, 6.5%, 7%, 7.5%, 8%, 8.5%, or 9%). In certain cases, sorbitol is used, typically in a concentration of from about 2% to about 5% (or any value therebetween such as 2.5%, 3%, 3.5%, 4%, or 4.5%). In other cases, propylene glycol is used, typically in a concentration of from about 0.5% to about 6% (or any value therebetween such as 1%, 1.5%, 2%, 2.5%, 3%, 3.5%, 4%, 4.5%, 5%, or 5.5%).

An edible ink composition can include one or more optional pH regulators and/or preservatives, which can be selected from the group consisting of citric acid, sodium hydroxide, potassium hydroxide, lemon juice (including lemon juice concentrate), sorbic acid, potassium sorbate, and sodium benzoate. In certain cases, citric acid is used. In other cases, lemon juice or a lemon juice concentrate is used. In yet other cases, potassium hydroxide is used. In other cases, a mixture of potassium hydroxide and citric acid is used, or a mixture of lemon juice (or a lemon juice concentrate) and potassium hydroxide, or a mixture of lemon juice (or a lemon juice concentrate) and citric acid. One or more pH regulators and/or preservatives can be included in a total amount ranging from about 0.5% to about 10%, or any value therebetween (about 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 3%, 3.2%, 3.4%, 3.6%, 3.8%, 4%, 4.2%, 4.4%, 4.6%, 4.8%, 5%, 5.2%, 5.3%, 5.4%, 5.5%, 5.6%, 5.7%, 5.8%, 5.9%, 6%, 6.2%, 6.4%, 6.6%, 6.8%, 6.9%, 7%, 7.1%, 7.2%, 7.3%, 7.4%, 7.5%, 7.6%, 7.7%, 7.8%, 7.9%, 8%, 8.1%, 8.2%, 8.4%, 8.6%, 8.8%, 9%, 9.2%, 9.4%, 9.6%, or 9.8%). In certain cases, one or more pH regulators and/or preservatives can be included in a total amount ranging from about 1.1% to about 2.9%, or from about 5% to about 8.5%.

If the edible article is to be frozen prior to consumption, an organic formulation of the edible ink may be used to provide an image layer on the edible article that is freeze/store stable. The organic formulation of the edible ink includes about 70% to about 80% by weight of a barrier forming compound to seal the image layer and protect it from water produced in the thawing process. The organic formulation of the edible ink also preferably includes about 1% to about 10% by weight of a drying agent, about 10% to about 20% by weight of a film former, about 1% to about 3% by weight of an emulsifier, about 1% to about 5% by weight water, and about 1% by weight of a water repellant.

The barrier forming compound acts as a pigment carrier, enhances adhesion to the printing plate (stickiness), and forms a skin layer to protect the image layer from water produced during thaw. Preferred barrier forming compounds include shellac/glaze solutions, as well as waxes such as beeswax and carnauba wax. Typical shellac formulations include about 40% by weight of a shellac and about 60% by weight of an alcohol. The barrier forming compound is preferably present in the organic edible ink formulation at a concentration of about 75% by weight.

The drying agent may vary widely depending on the desired evaporation rate of the edible ink formulation, as well as on the characteristics of the substrate to which the edible ink is to be applied. Preferred drying agents include alcohols such as methyl alcohol, ethyl alcohol, isopropyl alcohol and butyl alcohol, as well as mixtures thereof. A preferred mixture of alcohols includes about 1.5% by weight of each of isopropyl, ethyl and butyl alcohols.

At least one film former should be included in the organic formulation of the edible ink of the invention at a concentration sufficient to allow the image layer adhere to the printing plate and then “skin” rapidly after it is applied to a particular substrate. These compounds provide the edible ink composition with sufficient intrinsic strength to release from a printing plate or a roller in a printing apparatus. A preferred organic formulation includes about 15% by weight of the film former. Suitable film formers include gums such as gum acacia, locust bean gum, guar gum, methylcellulose, polyvinylpyrrolidone, gelatins, carrageenan, pectin, purified shellacs, methocel and hydroxypropylmethylcellulose. Polyvinylpyrrolidone (PVP) and hydroxypropylmethylcellulose are particularly preferred, and preferred formulation includes about 5% by weight polyvinylpyrrolidone and about 10% by weight hydroxypropylmethylcellulose.

The organic formulation of the edible ink should include about 1% to about 3% by weight, preferably about 2% by weight, of an emulsifier and/or a hydrocolloid stabilizer. Suitable emulsifiers include, for example, lecithin, crillet and polyoxyethylene sorbitan monostearate (TWEEN). Suitable hydrocolloid stabilizers include, for example, xanthan gum, sodium alginate, sorbitol, and starches such as maize starch, corn starch and potato starch. Lecithin and sodium alginate are particularly preferred.

The organic formulation of the edible ink further includes about 1% by weight of a water repellant. Suitable water repellants include dimethylpolysiloxane.

The edible ink formulation may be applied to an ink receptive image on a master in any suitable lithographic printing apparatus or process. The edible ink formulation adheres to the receptive image and forms an ink layer thereon. For example, printing processes that may be used include, wet offset, lithographic blanket transfer, flexographic Anolux roller transfer, letter press rotary relief plate, web print, reel to reel and gravure.

Preferred printing apparatus include dry offset printers available from Heidelberg Druckmaschinen AG, Heidelberg, Germany, A.B. Dick-Itek Limited, Middlesex, England and Sakurai Machinery, Koto-ku, Tokyo, Japan. In a dry offset process, the master is typically a photopolymer plate to which an ink receptive image is applied. The ink receptive image may be created on the master by, for example, typing or a photographic process. The edible ink is then applied to the ink receptive image on the master to form an ink layer thereon. The ink may be applied to the master by any suitable technique, and is typically applied using via a series of rubber blanket rollers, at an ink bed thickness of about 10 to about 20 microns.

The ink layer then releases cleanly from the printing plate and is subsequently transferred to a surface of a food article or a transfer sheet to produce an image layer thereon. For example, in the typical lithographic printing press, the transfer of the built up ink layer on the master to the edible article or transfer sheet is made via an intermediary blanket cylinder. The edible article or transfer sheet picks up the ink layer from the blanket cylinder, typically a rubber roller, as the article/sheet passes between the blanket cylinder and an impression cylinder. The transfer of the ink layer from the blanket cylinder to form the image layer on the edible article/transfer sheet should be conducted at a suitable temperature and relative humidity to achieve a clean and total transfer of the ink layer. The resultant image layer should be clearly defined, with sharp edges, a correct tonal value, and accurate color registration.

The image layer, which typically is applied on the edible article or transfer sheet at a thickness of about 4 microns to about 6 microns, should preferably become substantially non-tacky to the touch in about 1 minute in air under suitable transfer and drying conditions. Suitable transfer and drying conditions for the image layer are a temperature of about 18-20° C. at about 63-70% relative humidity. The image layer should also preferably become dry to the touch in about 5 minutes under these transfer and drying conditions. This prevents inadvertent running and/or smearing and facilitates the use of the ink composition in a high volume production process. If necessary in a high volume application, heat may optionally be used to reduce drying time.

The surfaces on which the edible (printed) image layer may be applied may vary widely, and may include any surface with sufficient strength and suitable surface characteristics to accept the transfer. Examples include relatively thin edible materials such as wafers, rice paper, sugar fondant paste, sugar sheets, starch sheets, icings on confections such as cakes, cupcakes, muffins, doughnuts, cookies and the like, as well as chocolates, candy coatings and ice cream. The transfer sheets, which are typically non-edible materials, may be selected from any material suitable for contact with foods. The materials used for the transfer sheet should be substantially free of surface non-food grade chemicals that could potentially contaminate an edible article or the edible ink. Suitable materials for the transfer sheet include papers having thereon a coating of a plastic or a wax. Papers coated with polypropylene or acetates are preferred.

The edible ink formulations may be provided as part of a decorating kit for use in decorating an edible article. The kit may include a lithographic printer master and the edible ink for use in a lithographic printer. The kit may also include a transfer sheet having applied on at least one surface thereof an image layer of the edible ink.

If the edible ink is applied to a transfer sheet, and the resultant ink layer is contacted with the surface of an edible article, the ink layer softens and becomes flowable. Once the ink becomes flowable, the transfer sheet may be removed. As the transfer sheet is peeled away, the ink releases substantially completely from the transfer sheet and transfers to the surface of the edible article to form an image layer thereon. Preferably, transfer of a full and complete image takes about 20 seconds at room temperature. To enhance transfer speed and efficiency, the surface of the edible article may optionally be moistened with any suitable wetting agent. Water is particularly preferred for this purpose.

If the surface of the edible article is non-porous, once the transfer sheet is removed the ink layer dries to form a colorfast and brilliantly colored image layer on the surface. However, if the surface is porous, such as, for example, a cake icing, the flowable ink penetrates and is absorbed into the porous surface. Following this penetration step, at least a portion of the image layer lies beneath the surface. This provides an image layer that is particularly resistant to smearing and bleeding. Heat may be used to reduce the drying time of the image layer.

The printing process of the invention may be a part of any known process for making an edible article. Once an edible article is formed and baked or otherwise processed, a coating is applied to the article, such as an icing, chocolate, a hard coating or the like. An image layer may then be formed on a portion of an exposed surface of the coating using the process described above.

The invention will now be described with reference to the following non-limiting examples.

### EXAMPLES

Example 1 - Colored Ink Formulations

| | |
|---|---|
| Black: | |
| Copper chlorophyll liquid | (250 g, GNT*) |
| Shade grape blue liquid | (250 g, GNT*) |
| Fondant icing sugar | (250 g) |
| Water | (50 g) |
| Green: | |
| Copper chlorophyll liquid | (250 g, GNT*) |
| Shade lemon yellow | (50 g, GNT*) |
| Fondant icing sugar | (125 g) |
| Lecithin | (25 g) |
| Orange: | |
| Shade lemon yellow | (300 g, GNT*) |
| Shade cherry red | (100 g, GNT*) |
| Fondant icing sugar | (150 g) |
| Lecithin | (10 g) |
| Water | (25 g) |
| Sorbitol | (25 g) |
| Red: | |
| Shade lemon yellow | (300 g, GNT*) |
| Shade cherry red | (300 g, GNT*) |
| Fondant icing sugar | (150 g) |
| Lecithin | (10 g) |
| Water | (25 g) |
| Sorbitol | (25 g) |

*Formulations from GNT International B.V. that include plant-derived
pigments (extracts) are as follows:
GNT Shade cherry red (GNT International B.V. Product No. 153330)

Black carrot extract (70-90%)
Black currant extract (3-10%)
Invert sugar (5-25%)
Citric acid (<5%)

GNT Shade lemon yellow (GNT Inter-national B.V. Product No. 548310)
Safflower extract (40-60%)
Lemon juice concentrate (5-10%)
Invert sugar (35-55%)
Citric acid (<5%)
GNT Copper Chlorophyllin (GNT International B.V. Product No. 700002)

Copper chlorophyllin (E 141) (9.5%-10.5%)
Polysorbate 80 (E 433) (60-70%)
Propylene glycol (2.5-10%)
Potassium hydroxide (E 525) (0.5-2.0%)
Water (15-25%)

GNT Shade grape blue (GNT International B.V. Product No. 183904)

Black carrot extract (60-80%)
Hibiscus extract (5-10%)
Invert sugar (10-30%)
Citric acid (<5%)

Each ink was prepared by weighing ingredients into a container and mixing with a Silverson high shear mixer for 10 minutes.

### Example 2

### Use of An Edible Ink in Printing

The black ink described above can be used to provide a keyline for a printed design.

A number of embodiments of the invention have been described. Nevertheless, it will be understood that various modifications may be made without departing from the spirit and scope of the invention. Accordingly, other embodiments are within the scope of the following claims.

1. An edible ink comprising a plant-derived pigment.

2. The edible ink of claim 1, further having a viscosity of about 1000 to about 16000 cp at 25° C.

3. An edible ink composition comprising water, one or more sweeteners, one or more emulsifiers, one or more humectants, and a plant-derived pigment.

4. The edible ink of claim 3, wherein said plant-derived pigment is derived from red currant, black currant, carrot, black carrot, blueberries, cabbage, red cabbage, spinach, safflower, hibiscus, red beet, golden beet, rose, tomato, strawberry, elderberry, raspberry, cherry, blackberry, plum, blue grapes, purple grapes, red grapes, asparagus, bell pepper, broccoli, grass, lucerne, nettle, alfalfa, algae, and curcumin.

5. The edible ink of claim 3, wherein the sweetener is selected from the group consisting of sugar, fructose, sucrose, aspartame, dextrose, dextrose monohydrate, glucose, glucose syrup, icing cane sugar, fondant icing sugar, invert sugar, and mixtures thereof.

6. The edible ink of claim 3, wherein the sweetener is a mixture of fondant icing sugar and invert sugar.

7. The edible ink of claim 3, wherein the emulsifier is selected from the group consisting of polysorbate 80, Tween 80, polysorbate 60, Tween 60, glycerin, polyoxyethylene sorbitan monostearate, crillet, polyglycerol polyricinoleate, acetic esters of monoglycerides, citric acid esters, lecithin, and mixtures thereof.

8. The edible ink of claim 3, wherein the humectant is selected from the group consisting of xylitol, mannitol, polyethylene glycol, propylene glycol, sorbitol, and mixtures thereof.

9. A printing process comprising applying the ink of claim 3 to a substrate.

10. A lithographic printing process for forming an image layer on a surface of an edible article, comprising:
(a) providing a master with an ink receptive layer thereon;
(b) contacting the ink receptive layer with the edible ink of claim 3 to form an ink layer thereon;
(c) transferring the ink layer to a substrate to form an image layer thereon.

11. The process of claim 10, wherein the substrate is selected from the group consisting of wax coated paper, plastic coated paper and acetate paper.

12. The process of claim 11, wherein the plastic coated paper is a polypropylene coated paper.

13. The process of claim 10, wherein the substrate is selected from the group consisting of sugar fondants, wafers, rice paper, starch sheets, sugar sheets, and icings.

14. The process of claim 10, wherein step (c) comprises transferring the ink layer to a surface of a blanket cylinder, and transferring the ink layer from the blanket cylinder to the substrate to form an image layer thereon.

15. The process of claim 14, wherein the blanket cylinder is a rubber roller.

16. A decorating kit comprising a substrate having printed thereon a layer of an edible ink of claim 3, wherein the edible ink is applied to the substrate using a lithographic printing process.

17. A lithographic printer comprising a master having an edible ink of claim 3 thereon.
